(19) United States
(12) Patent Application Publication
(10) Pub. No.: US 2026/0066327 A1
(43) Pub. Date: Mar. 5, 2026

(54) FUEL CELL MODULE

(71) Applicant: TOYOTA JIDOSHA KABUSHIKI KAISHA, Toyota-shi (JP)

(72) Inventors: Yuki KASAHARA, Susono-shi (JP); Masaaki MATSUSUE, Mishima-shi (JP)

(21) Appl. No.: 19/294,572

(22) Filed: Aug. 8, 2025

(30) Foreign Application Priority Data
Sep. 3, 2024 (JP) 2024-151479

(51) Int. Cl. H01M 8/2484; H01M 8/04119; H01M 8/04746; H01M 8/04791; H01M 8/04828

(52) U.S. Cl. CPC H01M 8/2484; H01M 8/04179; H01M 8/04753; H01M 8/04798; H01M 8/04835

(57) ABSTRACT

A fuel cell module may include: a fuel cell stack including a plurality of fuel cells stacked on one another, the fuel cell stack including a first end face at one end in a stacking direction of the fuel cells and a second end face at another end in the stacking direction; an oxidant inlet manifold including an oxidant supply port on the first face and configured to receive oxidant gas and a first oxidant discharge port on the second face; an oxidant outlet manifold configured for oxidant gas that has passed through each fuel cell to flow through the oxidant outlet manifold, and including a second oxidant discharge port on the second face; a discharge passage connected to the second oxidant discharge port and configured to discharge oxidant gas from the oxidant outlet manifold; and a branch passage connecting the first oxidant discharge port and the discharge passage.

### CROSS REFERENCE TO RELATED APPLICATION(S)

This application claims priority from Japanese Patent Application No. 2024-151479 filed on Sep. 3, 2024. The entire content of the priority application is incorporated herein by reference.

### TECHNICAL FIELD

The art disclosed herein relates to a fuel cell module.

### BACKGROUND ART

A fuel cell module disclosed in JP-A2020-155212 has a fuel cell stack having a plurality of fuel cells that are stacked on one another. The fuel cell stack generates electricity by reaction between fuel gas and oxidant gas.

### SUMMARY

In a fuel cell module, a branch passage may be provided to connect an oxidant gas supply passage upstream of a fuel cell stack and an oxidant gas outlet passage downstream of the fuel cell stack. By adjusting a flow rate of the oxidant gas in the branch passage, the flow rate of the oxidant gas through the fuel cell stack can be adjusted. In many fuel cell modules, an oxidant gas supply passage is connected to one end of the fuel cell stack and an oxidant gas outlet passage is connected to another end of the fuel cell stack. Therefore, a total length of a branch path is longer than a total length of the fuel cell stack, making it difficult to downsize a fuel cell module. This specification proposes a technology to downsize a fuel cell module with a branch passage.

### Aspect 1

A fuel cell module disclosed herein may comprise a fuel cell stack comprising a plurality of fuel cells that are stacked on one another, the fuel cell stack comprising a first end face located at one end in a stacking direction of the plurality of fuel cells and a second end face located at another end in the stacking direction; an oxidant gas inlet manifold extending along the stacking direction inside the fuel cell stack, comprising an oxidant gas supply port on the first end face and configured to receive oxidant gas and a first oxidant gas discharge port on the second end face, wherein the oxidant gas inlet manifold is configured for oxidant gas to flow from the oxidant gas inlet manifold to each of the plurality of fuel cells; an oxidant gas outlet manifold extending along the stacking direction inside the fuel cell stack, configured for oxidant gas that has passed through each of the plurality of fuel cells to flow through the oxidant gas outlet manifold, and comprising a second oxidant gas discharge port on the second end face; a discharge passage connected to the second oxidant gas discharge port and configured to discharge oxidant gas from the oxidant gas outlet manifold; and a branch passage connecting the first oxidant gas discharge port and the discharge passage.

In the fuel cell module described above, the branch passage connects the first oxidant gas discharge port on the second end face with the discharge passage extending from the second end face, thus the branch passage can be shortened. Therefore, the fuel cell module can be downsized.

### BRIEF DESCRIPTION OF DRAWINGS

FIG. 1 is a schematic diagram of a fuel cell module.

FIG. 2 is a flowchart of an operation process of the fuel cell module.

FIG. 3 is a flowchart of the operation process of the fuel cell module.

FIG. 4 is a flowchart of the operation process of the fuel cell module.

FIG. 5 is a flowchart of the operation process of the fuel cell module.

### DETAILED DESCRIPTION

Following Aspect 1 above, additional configurations of the fuel cell system disclosed herein are described below.

### Aspect 2

The fuel cell module according to aspect 1, may further comprise: an air compressor configured to supply oxidant gas from the oxidant gas supply port to the oxidant gas inlet manifold; a first valve configured to open and close the discharge passage at an upstream side of a connection part between the discharge passage and the branch passage; a second valve configured to open and close the branch passage; and a controller configured to execute a gas-and-water discharge operation in which the air compressor supplies oxidant gas to the oxidant gas inlet manifold with the first valve closed and the second valve opened after the fuel cell stack has stopped generating power.

### Aspect 3

The fuel cell module according to aspect 1, may further comprise: an air compressor configured to supply oxidant gas from the oxidant gas supply port to the oxidant gas inlet manifold; and a controller configured to execute a fuel gas concentration decreasing operation in which the air compressor repeatedly increases and decreases a pressure of oxidant gas in the oxidant gas inlet manifold with the discharge passage and the branch passage closed before the fuel cell stack starts generating power.

According to Aspect 2, water that adhered to the second valve during power generation can be blown off by the oxidant gas supplied from the air compressor after power generation has been stopped.

According to Aspect 3, the fuel gas concentration in the oxidant gas inlet manifold can be lowered by the fuel gas concentration decreasing operation when fuel gas has accumulated in the oxidant gas inlet manifold while power generation is stopped. This can suppress highly concentrated fuel gas from being discharged from the fuel cell stack to outside when power generation is started.

### First Embodiment

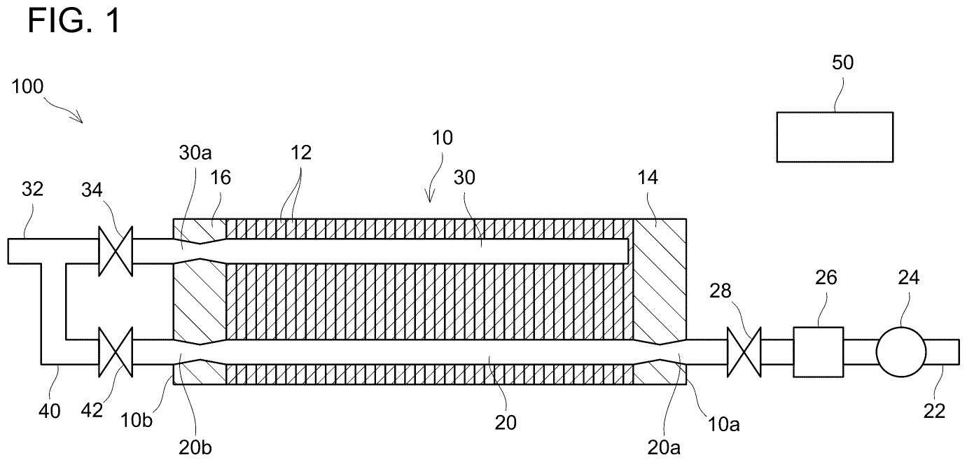

A fuel cell module 100 of embodiment 1 shown in FIG. 1 is installed in a device that uses a fuel cell as a power source (e.g., a fuel cell electric vehicle). The fuel cell module 100 comprises a fuel cell stack 10. The fuel cell module 100 supplies power generated by the fuel cell stack 10 to a motor or other devices.

The fuel cell stack 10 comprises a plurality of fuel cells 12 that are stacked on one another, an end plate 14, and an end plate 16. One end of the fuel cells 12 is covered by the end plate 14, and another end of the fuel cells 12 is covered by the end plate 16. In other words, the stack of fuel cells 12 is sandwiched between the end plate 14 and the end plate 16 in its stacking direction. In the fuel cell stack 10, an end face on an end plate 14 side is referred to as a first end face 10a and an end face on an end plate 16 side is referred to as a second end face 10b.

As shown in FIG. 1, an oxidant gas inlet manifold 20 is disposed inside the fuel cell stack 10. The oxidant gas inlet manifold 20 extends through each fuel cell stack 12, the end plate 14, and the end plate 16 and along an interior of the fuel cell stack 10 in the stacking direction. The oxidant gas inlet manifold 20 comprises an oxidant gas supply port 20a and an oxidant gas discharge port 20b. The oxidant gas supply port 20a is open to the first end face 10a. The oxidant gas discharge port 20b is open to the second end face 10b. Oxidant gas (e.g., air) is supplied to the oxidant gas supply port 20a from a supply passage 22 described below. The oxidant gas supplied from the oxidant gas supply port 20a flows from the oxidant gas inlet manifold 20 to each fuel cell 12. Each fuel cell 12 is supplied with oxidant gas from the oxidant gas inlet manifold 20 and fuel gas (e.g., hydrogen) from an unillustrated fuel gas manifold. Each fuel cell 12 generates electricity by reaction between the oxidant gas and fuel gas.

The fuel cell module 100 comprises the supply passage 22, an air compressor 24, an intercooler 26, and an inlet valve 28. An upstream end of the supply passage 22 is connected to an oxidant gas supply source, not shown. A downstream end of the supply passage 22 is connected to the oxidant gas supply port 20a. The supply passage 22 supplies oxidant gas to the oxidant gas inlet manifold 20.

The air compressor 24 is installed in the supply passage 22. The air compressor 24 pressurizes oxidant gas in the supply passage 22 and delivers the same downstream.

The intercooler 26 is located in the supply passage 22, downstream of the air compressor 24. High-pressure, high-temperature oxidant gas supplied from the air compressor 24 flows through the intercooler 26. Coolant is supplied to the intercooler 26 from an unillustrated cooling passage. The intercooler 26 cools oxidant gas with the coolant.

The inlet valve 28 is disposed in the supply passage 22, downstream of the intercooler 26. The inlet valve 28 adjusts a flow rate of oxidant gas supplied from the supply passage 22 to the oxidant gas inlet manifold 20 by adjusting an opening degree of the supply passage 22.

As shown in FIG. 1, an oxidant gas outlet manifold 30 is disposed inside the fuel cell stack 10. The oxidant gas outlet manifold 30 extends through each fuel cell stack 12 and the end plate 16 and along the interior of the fuel cell stack 10 in the stacking direction. The oxidant gas outlet manifold 30 comprises an oxidant gas discharge port 30a. The oxidant gas discharge port 30a is open to the second end plate 10b. Oxidant gas that has passed through the respective fuel cells 12 flows into the oxidant gas outlet manifold 30.

The fuel cell module 100 comprises a discharge passage 32 and a pressure regulating valve 34. The upstream end of the discharge passage 32 is connected to the oxidant gas discharge port 30a. Oxidant gas flowing in the oxidant gas outlet manifold 30 is discharged to outside of the fuel cell stack 10 via the discharge passage 32. The discharge passage 32 is provided with a pressure regulating valve 34. The pressure regulating valve 34 opens and closes flow in the discharge passage 32. A pressure in the oxidant gas outlet manifold 30 is adjusted by adjusting an opening degree of the pressure regulating valve 34.

The fuel cell module 100 comprises a branch passage 40 and a branch valve 42. An upstream end of the branch passage 40 is connected to the oxidant gas discharge port 20b. A downstream end of the branch passage 40 is connected to the discharge passage 32 downstream of the pressure regulating valve 34. The branch valve 42 is disposed in the branch passage 40. The branch valve 42 opens and closes flow in the branch passage 40. When the branch valve 42 is open, a portion of oxidant gas flowing in the oxidant gas inlet manifold 20 flows into the branch passage 40. The oxidant gas in the branch passage 40 flows to the discharge passage 32. When an opening degree of the branch valve 42 is changed, the flow rate of oxidant gas flowing in the branch passage 40 is changed, and therefore the flow rate of oxidant gas flowing to each fuel cell 12 is also changed. Therefore, the flow rate of oxidant gas flowing to each fuel cell 12 can be adjusted by the branch valve 42.

The fuel cell module 100 comprises a controller 50. The controller 50 controls the air compressor 24, the inlet valve 28, the pressure regulating valve 34, and the branch valve 42.

When the fuel cell module 100 generates electricity, the controller 50 opens the inlet valve 28, the pressure regulating valve 34, and the branch valve 42. In addition, the controller 50 drives the air compressor 24. Thus, oxidant gas is supplied from the supply passage 22 to the oxidant gas inlet manifold 20. Thus, the oxidant gas is supplied to each fuel cell 12 from the oxidant gas inlet manifold 20. The controller 50 supplies fuel gas to each fuel cell 12 by controlling a fuel gas supply system. Each fuel cell 12 generates electricity by reaction between the oxidant gas and fuel gas. The oxidant gas that passes through each fuel cell 12 flows to the oxidant gas outlet manifold 30. The oxidant gas flows from the oxidant gas outlet manifold 30 to the discharge passage 32. A portion of the oxidant gas in the oxidant gas inlet manifold 20 passes through the branch passage 40, and flows into the discharge passage 32. The oxidant gas in the discharge passage 32 is discharged to the outside of the fuel cell module 100.

When the oxidant gas and fuel gas react in each fuel cell 12, water is generated as a byproduct of the reaction. The generated water is discharged from each fuel cell 12 to the oxidant gas inlet manifold 20 and the oxidant gas outlet manifold 30. The generated water discharged into the oxidant gas inlet manifold 20 passes through the branch passage 40 and flows together with the oxidant gas to the discharge passage 32. The generated water discharged into the oxidant gas outlet manifold 30 flows with the oxidant gas into the discharge passage 32. The generated water is discharged from the discharge passage 32 to the outside of the fuel cell module 100.

As described above, the oxidant gas flowing in the branch passage 40 bypasses each fuel cell 12 and flows to the discharge passage 32. Since both the oxidant gas discharge port 20b of the oxidant gas inlet manifold 20 and the discharge passage 32 are located on the second end face 10b side, the branch passage 40 connecting them can be shortened. In other words, the branch passage 40 can be made shorter than when the branch passage is disposed so as to connect the supply passage 22 and the discharge passage 32. Therefore, the fuel cell module 100 can be made smaller.

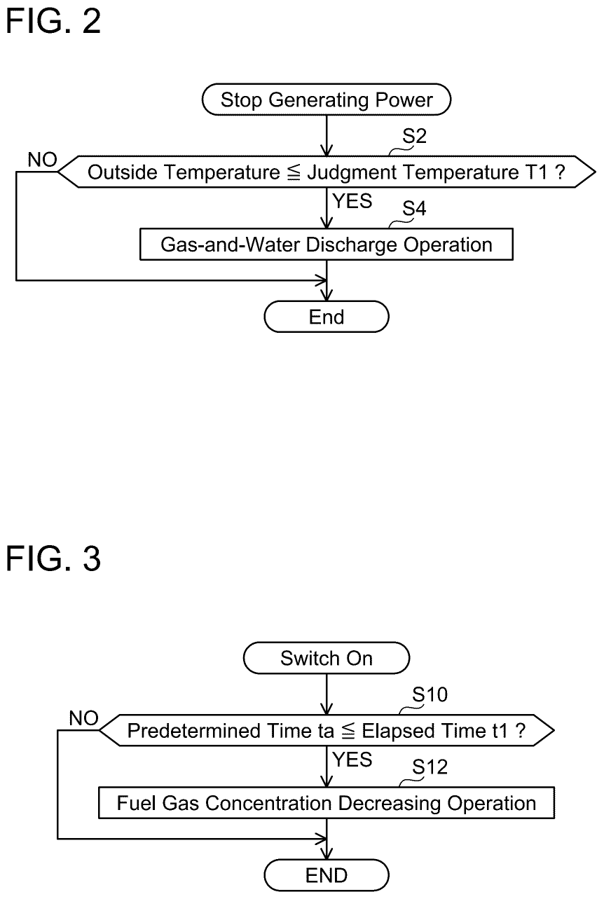

During power generation, the generated water may adhere to the branch passage 40 and the branch valve 42. In places of a cold climate, for example, the generated water adhering to the branch valve 42 may freeze, which may cause the branch valve 42 to be deteriorated. Therefore, the controller 50 can perform a gas-and-water discharge operation to remove the generated water adhering to the branch valve 42 after the fuel cell stack 10 has stopped generating power. The controller 50 selectively performs the gas-and-water discharge operation according to the flowchart in FIG. 2.

In step S2, the controller 50 measures an outside temperature by an unillustrated temperature sensor. The controller 50 determines whether the outside temperature is below a determination temperature T1 (e.g., 0° C.). The controller 50 executes the gas-and-water discharge operation in step S4 if the outside temperature is equal to or less than the determination temperature T1, and does not execute step S4 (i.e., the gas-and-water discharge operation) if the outside temperature is less than the determination temperature T1.

In the gas-and-water discharge operation, the controller 50 closes the pressure regulating valve 34 and opens the inlet valve 28 and the branch valve 42. The controller 50 also drives the air compressor 24. When the air compressor 24 is driven, oxidant gas is supplied to the oxidant gas inlet manifold 20. Since the pressure regulating valve 34 is closed, no oxidant gas flows from the oxidant gas inlet manifold 20 to each fuel cell 12. Therefore, all the oxidant gas supplied to the oxidant gas inlet manifold 20 is discharged through the branch passage 40 to the discharge passage 32. Therefore, in the gas-and-water discharge operation, the flow rate of oxidant gas flowing to the branch valve 42 is higher than in the power generation operation. Therefore, the generated water adhering to the branch valve 42 is blown away by the oxidant gas in the gas-and-water discharge operation. Therefore, the generated water is removed from the branch valve 42. Therefore, it is possible to suppress the generated water from being frozen on a surface of the branch valve 42 while power generation is stopped.

In FIG. 2, the controller 50 executes the gas-and-water discharge operation if the outside temperature is equal to or less than the determination temperature T1, but the controller 50 may execute the gas-and-water discharge operation after power generation has stopped regardless of the outside temperature.

After the fuel cell stack 10 has stopped generating power, fuel gas in an unillustrated fuel gas manifold may flow through each fuel cell 12 to the oxidant gas inlet manifold 20, and a concentration of fuel gas in the oxidant gas inlet manifold 20 may become high. If power generation is started while the fuel gas concentration in the oxidant gas inlet manifold 20 is high, the highly concentrated fuel gas in the oxidant gas inlet manifold 20 would be discharged to the outside of the fuel cell module 100. Therefore, the controller 50 can perform a fuel gas concentration decreasing operation to decrease the concentration of the fuel gas in the oxidant gas inlet manifold 20 before the fuel cell stack 10 starts generating power. The controller 50 selectively executes the fuel gas concentration decreasing operation according to the flowchart in FIG. 3.

The controller 50 can measure a time that has elapsed since the fuel cell stack 10 stopped generating power (hereinafter referred to as an elapsed time t1) by means of an unillustrated timer. When a main switch of the fuel cell stack 10 is turned on, the controller 50 determines in step S10 whether the elapsed time t1 is longer than a predetermined time ta (e.g., half a day). If the elapsed time t1 is equal to or longer than the predetermined time ta, the controller 50 performs the fuel gas concentration decreasing operation in step S12, and if the time t1 is less than the predetermined time ta, it does not perform step S12 (i.e., the fuel gas concentration decreasing operation). Since the longer the elapsed time t1 is, the higher the fuel gas concentration in the oxidant gas inlet manifold 20 becomes, according to the determination in step S10, the fuel gas concentration decreasing operation can be executed when the fuel gas concentration in the oxidant gas inlet manifold 20 is high.

In the fuel gas concentration decreasing operation, the controller 50 opens the inlet valve 28, and closes the pressure regulating valve 34 and the branch valve 42. The controller 50 also repeatedly increases or decreases the pressure of the oxidant gas in the oxidant gas inlet manifold 20 by driving and stopping the air compressor 24 in short cycles. As a result, fuel gas is spread throughout the supply passage 22 downstream from the air compressor 24 and throughout the oxidant gas inlet manifold 20, and the concentration of fuel gas in the oxidant gas inlet manifold 20 decreases.

After executing the fuel gas concentration decreasing operation, the controller 50 opens the pressure regulating valve 34 and the branch valve 42 to start power generation. When power generation starts, the fuel gas and oxidant gas in the oxidant gas inlet manifold 20 are discharged to the outside of the fuel cell module 100 through the pressure regulating valve 34 and the branch valve 42. Since the fuel gas concentration in the oxidant gas inlet manifold 20 is decreased by the fuel gas concentration decreasing operation, the highly-concentrated fuel gas can be suppressed from being discharged to the outside of the fuel cell module 100.

In the above fuel gas concentration decreasing operation, the pressure of the oxidant gas in the oxidant gas inlet manifold 20 is increased or decreased repeatedly by driving and stopping the air compressor 24 repeatedly in short cycles. However, in the fuel gas concentration decreasing operation, the air compressor 24 may be driven in an area where surge occurs. When the air compressor 24 is driven in the area where surge occurs, the flow rate of the oxidant gas discharged from the air compressor 24 oscillates between positive and negative values. This allows the pressure of the oxidant gas in the oxidant gas inlet manifold 20 to increase or decrease repeatedly.

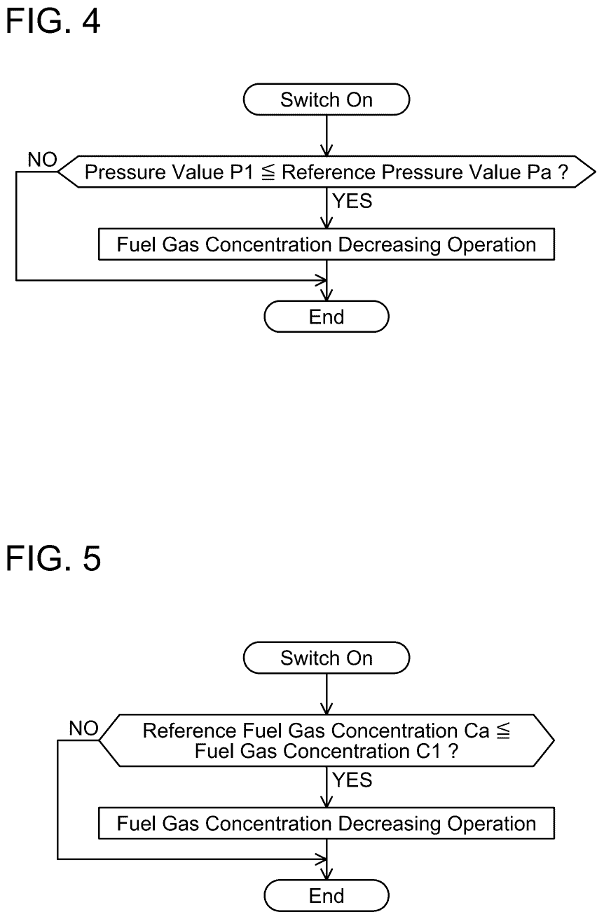

In the first embodiment described above, the controller 50 executes the fuel gas concentration decreasing operation when the elapsed time t1 is equal to or longer than the predetermined time ta. In contrast, as shown in the flowchart in FIG. 4, the controller 50 may execute the fuel gas concentration decreasing operation when a pressure value P1 of the fuel gas in an unillustrated fuel gas passage is equal to or less than a reference pressure value Pa. As shown in the flowchart in FIG. 5, the controller 50 may execute the fuel gas concentration decreasing operation when a fuel gas concentration C1 in the branch passage 40 upstream from the branch valve 42 is equal to or greater than a reference fuel gas concentration Ca. With configurations of FIGS. 4 and 5 also, the fuel gas concentration decreasing operation can be executed when the fuel gas concentration in the oxidant gas inlet manifold 20 is high. The controller 50 may also execute the fuel gas concentration decreasing operation before power generation starts regardless of the fuel gas concentration in the oxidant gas inlet manifold 20.

The oxidant gas outlet 20b is an example of “first oxidant gas discharge port”. The oxidant gas outlet 30a is an example of “second oxidant gas discharge port”.

The pressure regulating valve 34 is an example of “first valve”. The branch valve 42 is an example of “second valve”.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A fuel cell module, comprising:
a fuel cell stack comprising a plurality of fuel cells that are stacked on one another, the fuel cell stack comprising a first end face located at one end in a stacking direction of the plurality of fuel cells and a second end face located at another end in the stacking direction;
an oxidant gas inlet manifold extending along the stacking direction inside the fuel cell stack, comprising an oxidant gas supply port on the first end face and configured to receive oxidant gas and a first oxidant gas discharge port on the second end face, wherein the oxidant gas inlet manifold is configured for oxidant gas to flow from the oxidant gas inlet manifold to each of the plurality of fuel cells;
an oxidant gas outlet manifold extending along the stacking direction inside the fuel cell stack, configured for oxidant gas that has passed through each of the plurality of fuel cells to flow through the oxidant gas outlet manifold, and comprising a second oxidant gas discharge port on the second end face;
a discharge passage connected to the second oxidant gas discharge port and configured to discharge oxidant gas from the oxidant gas outlet manifold; and
a branch passage connecting the first oxidant gas discharge port and the discharge passage.

2. The fuel cell module according to claim 1, further comprising:
an air compressor configured to supply oxidant gas from the oxidant gas supply port to the oxidant gas inlet manifold;
a first valve configured to open and close the discharge passage at an upstream side of a connection part between the discharge passage and the branch passage;
a second valve configured to open and close the branch passage; and
a controller configured to execute a gas-and-water discharge operation in which the air compressor supplies oxidant gas to the oxidant gas inlet manifold with the first valve closed and the second valve opened after the fuel cell stack has stopped generating power.

3. The fuel cell module according to claim 1, further comprising:
an air compressor configured to supply oxidant gas from the oxidant gas supply port to the oxidant gas inlet manifold; and
a controller configured to execute a fuel gas concentration decreasing operation in which the air compressor repeatedly increases and decreases a pressure of oxidant gas in the oxidant gas inlet manifold with the discharge passage and the branch passage closed before the fuel cell stack starts generating power.
